(19) United States
(12) Patent Application Publication
(10) Pub. No.: US 2015/0013552 A1
(43) Pub. Date: Jan. 15, 2015

(54) FROTHING MACHINE FOR CONTROLLING FOAM VOLUME

(71) Applicant: Simatelex Manufactory Co. Ltd., Chaiwan (CN)

(72) Inventors: Kam Ming Tsang, Chaiwan (CN); Cyrus Luk, Chaiwan (CN)

(21) Appl. No.: 13/941,221

(22) Filed: Jul. 12, 2013

(51) Int. Cl. A01J 11/04

(52) U.S. Cl. CPC A01J 11/04
USPC 99/453

(57) ABSTRACT

The present invention relates to a milk frothing device that is capable of controlling foam volume. In particular, the milk frothing device includes a container with a cover, a stirrer disposed within the container, a motor for rotating the stirrer forward or backward, a set of rotation control elements for controlling the rotation direction of the motor and a base containing a heating element, a circuit board and a temperature sensor, the base attachable to the container. This invention discloses a device with a simple structure. The container does not contain any electric components and may be separated from the base which makes it easy and convenient for use and cleaning. This invention discloses a method for making foam with different volume through changing the rotating direction of the stirrer. Different foam volume may be generated to cater individuals' quest for texture and taste of drinks.

### TECHNICAL FIELD

The present invention relates to a milk frothing device, and in particular, a milk frothing device capable of generating foam with different volume.

### BACKGROUND OF THE INVENTION

Nowadays, people like to add foaming milk to coffee to give the coffee a more delicate taste and silky texture. On the other hand, beautiful froth patterns may be created on coffee to make the coffee more appealing. Cappuccino and latte are popular coffee drinks that have different foam volume, In fact, variation in foam volume may give a significantly different tasting experience. Thus the quality and volume of the foam have a strong influence on coffee tasting.

Milk foam, or froth, is formed by mixing milk with air or steam. The most common methods for milk frothing include steam blasting and stirring. Generally, adding heat to milk while frothing provides a better effect, and the foam formed remains intact for a longer period of time. The steam blasting method works by blasting milk with high temperature pressurized steam to create foam, where steam could heat the milk at the same time. Some major drawbacks of the steam blasting method are that milk will be diluted by the steam and the temperature of milk is difficult to control. Also, strong technical skills are required to create quality foam. Alternatively, the stirring method mixes air and milk with a set of high speed rotating stirrer while providing heat to the milk. This process is automated and does not require any manual control or technical skills, which is particularly favorable. Also, coffee may be brewed during milk frothing. Currently, milk frothing devices available in the market only give a single foam volume. To obtain different foam volume, at least two sets of stirrer with different shapes are required, in which one is for high foam volume and the other is for low foam volume.

Patent No. CN 102160761 A discloses a milk frothing device using magnets for rotation transmission. The device includes a supporting stand mounted on a shaft of the motor at the base. Magnets are installed inside a supporting stand and a heating plate is installed on the stand. When the supporting stand rotates, the magnet inside the supporting stand rotates accordingly. Milk frothing is performed when a magnet in a stirrer in a container is driven into rotation through magnetic interaction.

Patent No. CN 101904700 A discloses a milk frothing device directly driven by an electric motor installed in a base. The motor in the base drives a shaft that runs through the bottom of a container. The stirrer attached to the shaft is driven into rotation fir milk frothing. A major deficiency of this device is that there may be sealing problems after prolonged period of use.

Patent No. CN 10197210 A discloses a milk frothing device. Milk is filled in a container fitted on a base and is heated by a heating element while stirred by a ring-shaped spring. The spring is driven by a motor located inside a cover of the container. Contacting plates are located in the container and the container cover for electrical conduction. Foaming milk for cappuccino may be produced this way.

Currently, there are a lot of ways to perform milk frothing and create foam, yet methods for controlling the foam volume rarely exist. As a result, the present invention relates to a method capable of controlling the foam volume.

### SUMMARY OF THE INVENTION

The present invention provides a milk frothing device for controlling foam volume, the milk frothing device comprising a container having a cover; a stirrer disposed within the container; a motor having a shaft for rotating the stirrer; a rotation control element for controlling the director of the shaft of the motor and in turn rotating the stirrer forward or backward; and a base attachable to the container, the base including a heating element, a circuit board and a temperature sensor, wherein the foam volume is controlled by rotating the s stirrer forward or backward.

The motor may be located in the base, or alternatively, the motor may be located in the cover.

In one embodiment, a first magnet is disposed in the stirrer and interacts with a second magnet disposed in a supporting stand mounted on the shaft of the motor for rotation transmission.

In another embodiment, the milk frothing device includes a connector disposed between the shaft of the motor and the stirrer for rotation transmission. Preferably, the stirrer and the motor are connected through a connector and a connecting shaft for rotation transmission.

In one embodiment, the rotation control element is a sliding commutator that controls the rotating direction of the motor through a sliding button.

In another embodiment, the rotation control element is a rotary commutator that controls the rotation direction of the motor through a rotating knob.

In yet another embodiment, the rotation control element includes a circuit board that controls the rotation direction of the motor through a first button for rotating the stirrer in the one direction and a second button for rotating the stirrer in the other direction.

Preferably, the stirrer includes one or more than one individual blades, each blade having a wave-like structure.

Still preferably, the stirrer includes a plurality of semi-dome shaped blades spaced apart with a filter under each individual blade.

### BRIEF DESCRIPTION OF THE DRAWINGS

FIG. 1 shows a structural diagram of the milk frothing device for the first rotation transmission scheme using magnetic interactions;

FIG. 2 shows a structural diagram of the milk frothing device for the second rotation transmission scheme through direct connection;

FIG. 3 shows a structural diagram of the milk frothing device tier the third rotation transmission scheme by a top-down approach;

FIG. 4 shows a design of the base for the first rotation direction control scheme;

FIG. 5 shows a design of the base for the second rotation direction control scheme;

FIG. 6 shows a design of the base for the third rotation direction control scheme;

FIG. 7 shows a design of the first type of blades; and

FIG. 8 shows a design of the second type of blades.

### DETAILED DESCRIPTION OF THE EMBODIMENTS

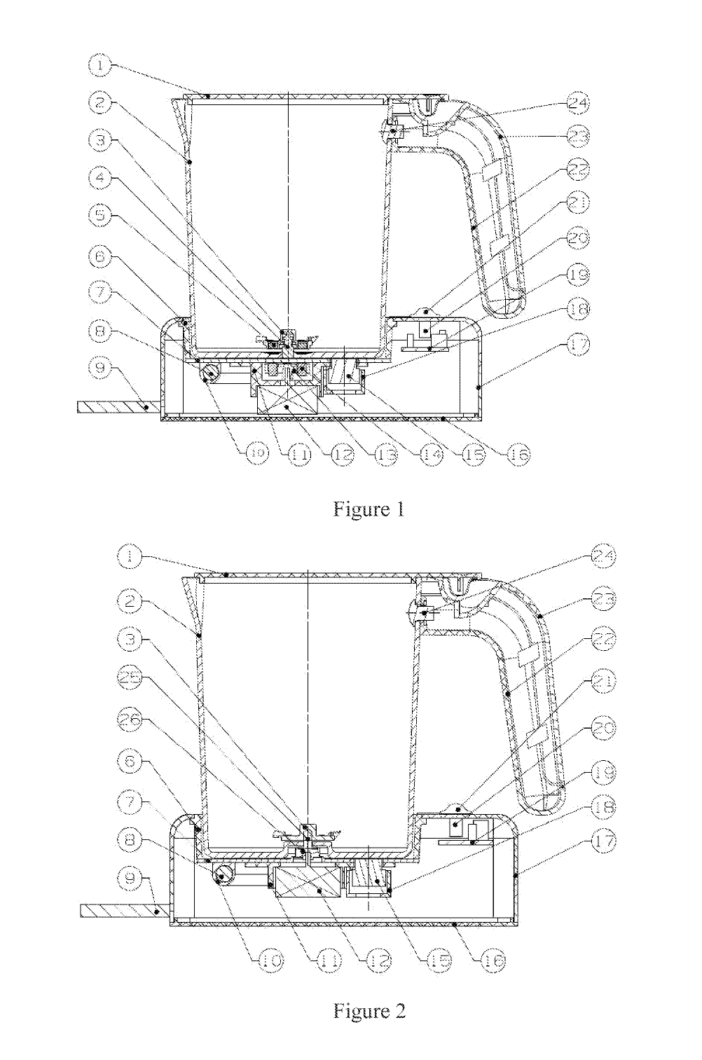

Different structures of a milk frothing device are shown in FIGS. 1, 2 and 3. In general, the milk frothing device includes a container with a cover, a stirrer disposed within the container, a motor for rotating the stirrer, a set of rotation control elements for controlling the rotation direction of the motor forward or backward, and a base containing a heating element, a circuit board and a temperature sensor, for housing the container.

As shown in FIG. 1, the container 2 is housed onto a hollowed circular region of the base 17. A positioning shaft 4 is riveted at the bottom center of the container 2. A stirrer 3 is fitted on the positioning shaft 4 and may be rotated during frothing. A heat insulating bakelite ring 6 is placed on the wall of the hollowed circular region of the base 17. An aluminum plate 7 that facilitates heat transmission and provides mechanical support to the container 2 is placed under the bakelite ring 6. Beneath the aluminum plate 7 is a heating element 8, a fixed bakelite base 11 and a supporting stand 13. The supporting stand 13 encloses a magnet 14 and is mounted on the shaft of motor 12. When the shaft of motor 12 rotates, the supporting stand 13 and the magnet 14 inside rotates accordingly. Magnet 14 drives magnet 5 that is enclosed in the stirrer 3 through magnetic interaction and sets the stirrer 3 into rotation. The fixed bakelite base 11 is in place for providing thermal insulation and fixing the position of the motor 12 underneath. A temperature sensor 15 in contact with the bottom of the container 2 is installed adjacent to the bakelite base 11 for monitoring the temperature of milk. Additionally, a circuit board 19 and a rotation control element, such as a sliding commutator 20, are installed in the base 17. A handle 23 is connected to a handle 22 and the combined handle is fixed to the container 2 with a bolt 24.

In one embodiment, the sliding commutator 20 may be replaced with a rotary commutator for controlling the rotation direction of the motor 12. Alternatively, the circuit board 19 may be specifically designed to control the rotation direction of the motor 12.

The milk frothing machine in FIG. 2 has the same structure as the one shown in FIG. 1, except that the supporting stand 13, magnet 14 and magnet 5 have been replaced by a connector 26. Connector 26 is installed between the shaft of motor 12 and the stirrer 3 for direct rotation transmission.

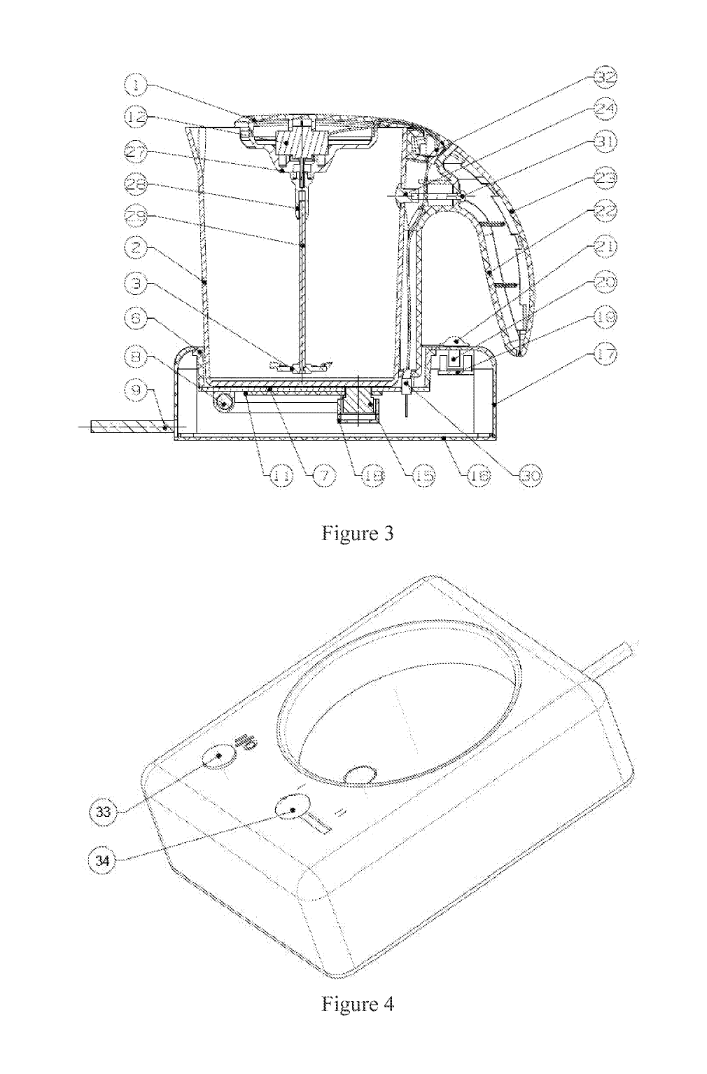

For the milk frothing device shown in FIG. 3, the motor 12 is housed inside the container cover 1 for top-down rotation transmission. Structurally, the shaft of the motor 12 is connected to the stirrer 3 through a connector 28 and a connecting shaft 29. Motor 12 derives its power from the circuit board 19 in the base 17, In detail, the circuit board 19 is connected to a contacting plate 30 through electric connections, The electric connections run through handle 22 and handle 23 and are further relayed by a contacting plate 32 to reach the motor 12 in the container cover 1.

FIG. 4 shows a design of the base 17 for the first rotation direction control scheme. Different volume of foam may be generated by controlling a sliding button 34 that controls the sliding commutator 20, which in turn controls the rotation direction of the shaft of the motor 12 and the stirrer 3.

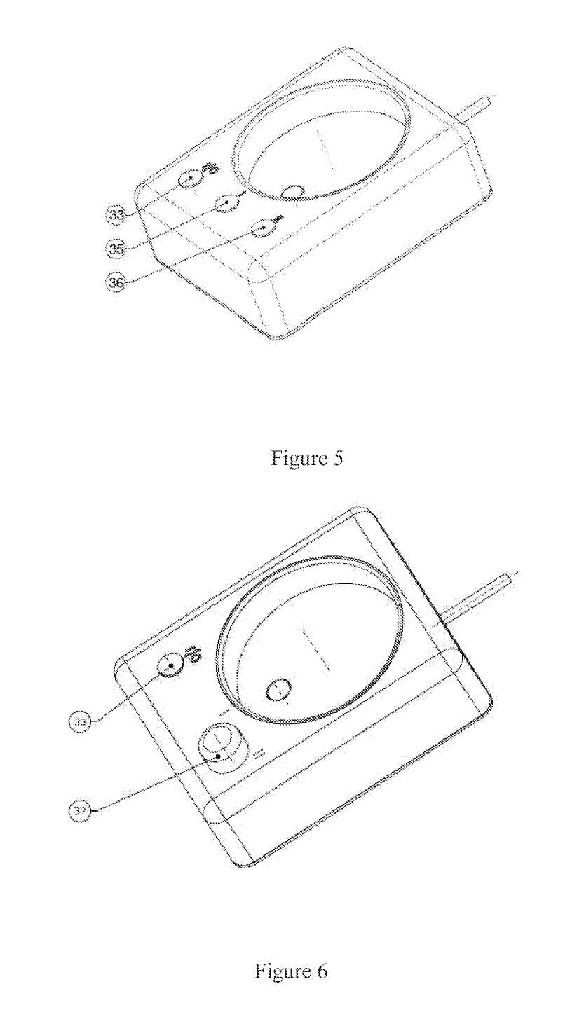

FIG. 5 shows a design of the base 17 for the second rotation direction control scheme. Different volume of foam may be generated by installing the circuit board 19 in the base 17. The circuit board 19 is used to control the rotation direction of the shaft of motor 12 and hence the rotation direction of the stirrer 3 through a first button 35 and a second button 36.

FIG. 6 shows a design of the base for the third rotation direction control scheme. Different volume of foam may be generated by controlling a rotating knob 37 that controls the rotary commutator, which in turn controls the rotation direction of the shaft of the motor 12 and the stirrer 3.

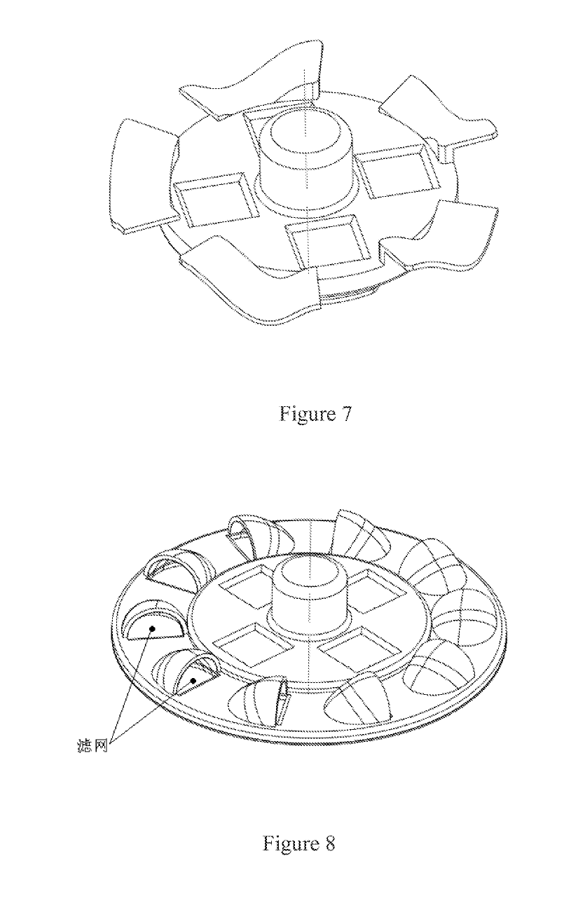

As shown in FIG. 7, the stirrer 3 comprises one or more than 1 individual blade, each blade having a wave-like structure. When the stirrer 3 is in a state of forward rotation, the resistive area of the stirrer 3 is more than double than that when the stirrer 3 is rotating backwards. Foam with different volume may thus be formed by manipulating the rotation direction of the stirrer 3.

As shown in FIG. 8, the stirrer 3 comprises a plurality of semi-dome shaped blades spaced apart with a filter under each individual blade. When the stirrer 3 is in the state of forward rotation, the milk passes through the semi-dome shaped blades and interacts with the filter to produce foam. There will be no such effect when the stirrer 3 rotates backwards.

1. A milk frothing device for controlling foam volume, the milk frothing device comprising:
a container having a cover;
a stirrer disposed within the container;
a motor having a shaft for rotating the stirrer;
a rotation control element for controlling the direction of the motor and in turn rotating the stirrer forward or backward; and
a base attachable to the container, the base including a heating element, a circuit board and a temperature sensor,
wherein the foam volume is controlled by rotating the stirrer forward or backward.

2. The milk frothing device of claim 1, wherein the motor is located in the base.

3. The milk frothing device of claim 1, wherein the motor is located in the cover.

4. The milk frothing device of claim 1, wherein a first magnet is disposed in the stirrer and interacts with a second magnet disposed in a supporting stand mounted on the shaft of the motor for rotation transmission.

5. The milk frothing device of claim 1, further including a connector disposed between the shaft of the motor and the stirrer for rotation transmission.

6. The milk frothing device of claim 1, wherein the stirrer and the motor are connected through a connector and a connecting shaft for rotation transmission.

7. The milk frothing device of claim 1, wherein the rotation control element is a sliding commutator that controls the rotating direction of the motor through a sliding button.

8. The milk frothing device of claim 1, wherein the rotation control element is a rotary commutator that controls the rotation direction of the motor through a rotating knob.

9. The milk frothing device of claim 1, wherein the rotation control element includes a circuit board that controls the rotation direction of the motor through a first button for rotating the stirrer in the one direction and a second button for rotating the stirrer in the other direction.

10. The milk frothing device of claim 1, wherein the stirrer includes one or more than one individual blades, each blade having a wave-like structure.

11. The milk frothing device of claim 1, wherein the stirrer includes a plurality of semi-dome shaped Hades spaced apart with a filter under each semi-dome shaped blade.
